(19) United States
(12) Patent Application Publication
(10) Pub. No.: US 2017/0090790 A1
(43) Pub. Date: Mar. 30, 2017

(54) CONTROL PROGRAM, CONTROL METHOD AND INFORMATION PROCESSING DEVICE

(71) Applicant: FUJITSU LIMITED, Kawasaki-shi (JP)

(72) Inventors: Naoki Nakatogawa, Kawasaki (JP); Yoshihiro Tsujikawa, Kobe (JP); Hisaya Fujii, Numazu (JP)

(73) Assignee: FUJITSU LIMITED, Kawasaki-shi (JP)

(21) Appl. No.: 15/240,330

(22) Filed: Aug. 18, 2016

(30) Foreign Application Priority Data
Sep. 28, 2015 (JP) 2015-189787

(51) Int. Cl. G06F 3/06

(52) U.S. Cl. CPC G06F 3/0619; G06F 3/065; G06F 3/067

(57) ABSTRACT

A non-transitory computer readable storage medium storing therein a control program that causes a computer to execute a process, the process includes selecting an operation execution log of an operation which is finished normally among a plurality of operation execution logs stored in a first storage in response to an operation which is executed for a second storage, and storing the operation execution log which is selected in a third storage for backup.

### CROSS-REFERENCE TO RELATED APPLICATION

This application is based upon and claims the benefit of priority of the prior Japanese Patent Application No. 2015-189787, filed on Sep. 28, 2015, the entire contents of which are incorporated herein by reference.

### FIELD

The embodiments discussed herein are related to a control program, a control method and an information processing device.

### BACKGROUND

A database management system stores data depending on the processing of business for a database. In addition, the database management system memorizes an archive log indicating the execution history of the operation depending on the operation for the database one by one.

The database management system copies and evacuates the database and the archive log for preparing the outbreak of the failure such as the disks of the database. And the database management system restores the database which evacuated when the failure occurs and reconstructs the database by applying the execution history included in the archive log to chronological command for the database which is restored.

For example, the technique about the reconstruction of the database at the time of the failure outbreak is disclosed in patent document 1 (See, for example, Japanese Laid-open Patent Publication No. HEI 5-143422).

### SUMMARY

According to an aspect of the embodiments, a non-transitory computer readable storage medium storing therein a control program that causes a computer to execute a process, the process includes selecting an operation execution log of an operation which is finished normally among a plurality of operation execution logs stored in a first storage in response to an operation which is executed for a second storage, and storing the operation execution log which is selected in a third storage for backup.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining a backup processing of database of the database management system according to an embodiment.

FIG. 2A and FIG. 2B are diagrams illustrating an example of archive log AL of the transaction.

FIG. 3 is a diagram explaining a flow of reconstruction processing f3 which is indicated in FIG. 1 schematically.

FIG. 4 is a diagram explaining a summary of the backup processing of archive log AL by the control program according to the embodiment schematically.

FIG. 5A and FIG. 5B are diagrams explaining an example of the execution history of the operation that normalcy finished.

FIG. 6 is a diagram explaining a flow of reconstruction processing f3x (referring to FIG. 4) based on the archive backup log ALx schematically.

FIG. 7 is a diagram of hardware constitution of information processing device 100 in the embodiment.

FIG. 8 is a diagram of constitution of the software block of information processing device 100 in FIG. 7.

FIG. 9 is a diagram of flow chart explaining a flow of the processing of backup module 122 in DB control program 120 depicted in FIG. 8.

FIG. 10 is a diagram indicating an example of database 105A at the time “tA”.

FIG. 11 is a diagram indicating an example of the transaction carried out for database 105A (FIG. 10) from time “tA” to time “tB”.

FIG. 12 is a diagram indicating database 105B at time tB which was updated by executing the transaction depicted in FIG. 11.

FIG. 13 is a diagram indicating an example of archive log AL which was generated when the transaction depicted in FIG. 11 is carried out.

FIG. 14 is a diagram indicating an example of archive backup log ALx formed according to backup processing of archive log AL depicted in FIG. 13.

FIG. 15 is a diagram a summary of the reconstruction processing in the embodiment schematically.

FIG. 16 is a diagram indicating an example of the group which is classified based on quantity of record for the reconstruction.

FIG. 17 is a diagram of flow chart explaining a processing flow of recovery module 123 of DB control program 120 depicted in FIG. 8.

FIG. 18 is a diagram explaining the gross weight of the record for the update of each page.

FIG. 19 is a diagram explaining the group classification of the execution history based on the quantity of record. Table H2 depicted in FIG. 19 has a group, page information, quantity of total record, information of the transaction ID.

### DESCRIPTION OF EMBODIMENTS

Embodiments will be described hereinafter according to the drawings. However, it is noted that the technical scope is not limited to the embodiments described below, but covers the matters described in the claims and the equivalents thereof.

### Summary of Backup Processing

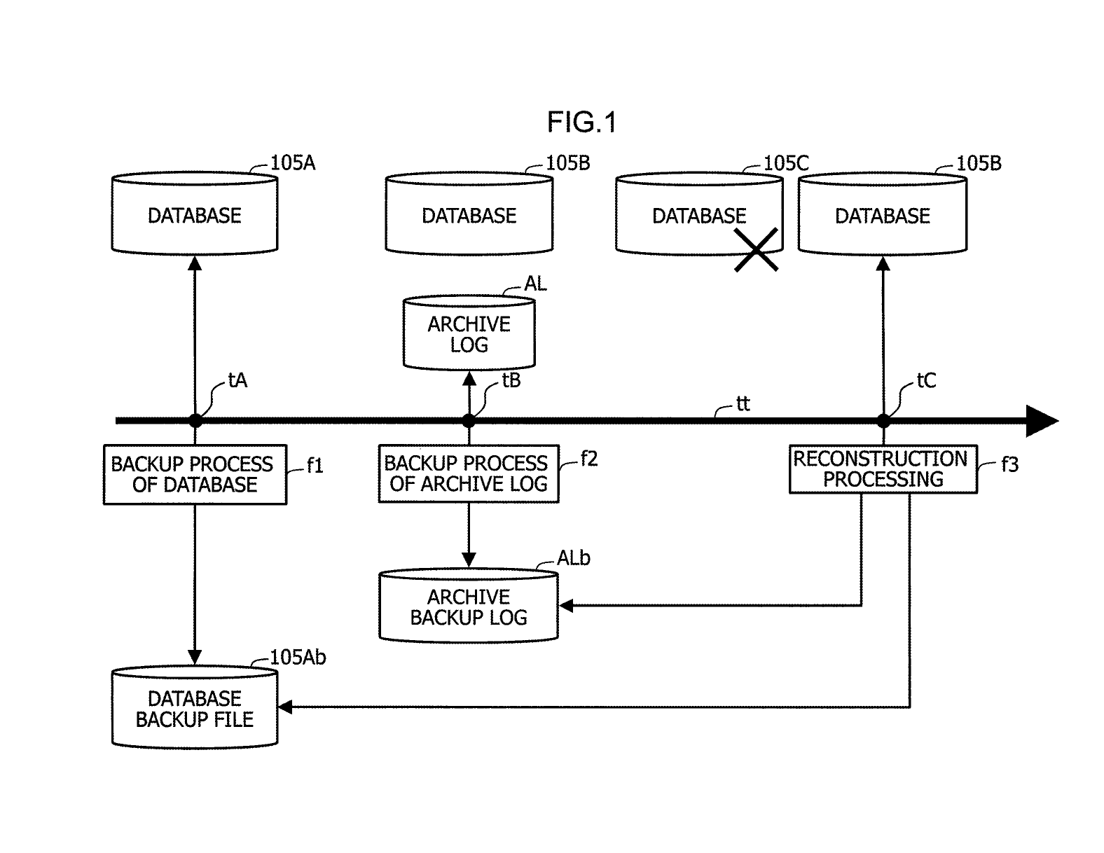

However, size of the archive log increases when a large quantity of update is carried out for a database. Accordingly, memory capacity to back up the archive log increases, and the cost increases. In addition, the archive log that are memorized for backup may suppress the area of the database. FIG. 1 is a diagram explaining a backup processing of database of the database management system according to an embodiment. In FIG. 1, an arrow “tt” indicates progress of the time.

In FIG. 1, a database 105A indicates a database at a time “tA”. In addition, a database 105B indicates a database at a time “tB” and represents a database that update was carried out for the database 105A. Similarly, a database 105C indicates a database at time “tC” and represents a database that update is performed more for the database 105B. The database 105A-105C depicted in FIG. 1 are also described as a database 105.

The database management system generates an execution history depending on operation (access processing) for the database 105 one by one and memorizes it as the archive log (also described operation execution log) AL. The archive log AL indicates history information of the operation for the database 105, and has operation information such as the insertion or the update of data in chronological command.

(time “tA”)

The database management system performs backup processing f1 of the database 105A during maintenance periods, for example. The database management system generates copying of the database 105A as backup processing f1 and stores it in storage medium, as the database backup file (below called as DB backup file) 105Ab.

However, when the database 105A stores a large quantity of records a time needed for the backup processing f1 gets longer. Therefore, during a maintenance period, the backup processing f1 may not be completed. In addition, when performing the backup processing f1 frequently, the capacity of the storage medium for memorizing the DB backup file 105Ab may be short.

Therefore, the database management system performs a backup processing f2 of the archive log AL according to an interval at shorter time for an execution interval between the backup processing f1. Because the archive log AL has a small size for the database 105A, time needed for the backup processing f2 is shorter than the time needed for the backup processing f1.

(Time “tB”)

The database management system generates copying of the archive log AL as the backup processing f2 of the archive log AL and memorizes it in the storage medium as the archive backup log ALb. The archive log AL indicated in FIG. 1 has history information of the operation for the database 105A from the time “tA” until a time “tB”.

(time “tC”)

The time “tC” indicates the time point when the failure such as disks of the database occurred. The database management system reconstructs contents of the database 105B at a time “tB” based on the DB backup file 105Ab and the archive backup log ALb as the reconstruction processing f3.

Particularly, the database management system reconstructs the contents of the database 105A at the time “tA” by restoring the DB backup file 105Ab. And the database management system reconstructs contents of database 105B at the time “tB” by reflecting execution history from the time “tA” to the time “tB” in the archive backup log ALb for the database 105A after restoring in chronological order.

### Transaction

The database management system carries out the operation (access processing) of the database by performing an SQL (Structured Query Language) command (inquiry). The SQL command is a database language (query language) which instructs access processing of data for the database 105 and a definition of database 105 (query language). For example, the access processing indicates a search (SELECT) of data, additional (INSERT), deletion (DELETE) and update (UPDATE).

The transaction indicates a unit of one relevant processing and includes plural SQL commands. The transaction normally finishes by validating the processing of each SQL command included in the transaction by the COMMIT command. In other words, when the COMMIT command is executed, the update for the database by each SQL command of the transaction is settled. In other words, it is not decided whether the update of each SQL command of the transaction was reflected to the database 105 until the transaction is completed.

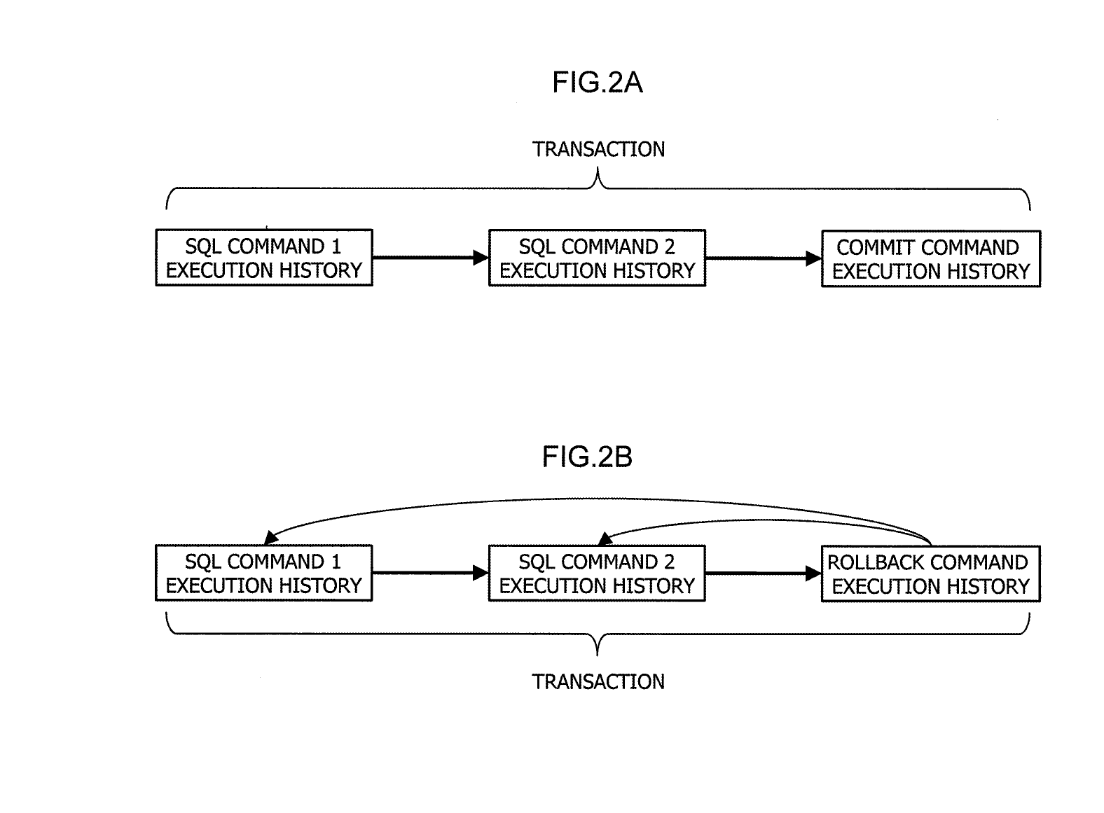

FIG. 2A and FIG. 2B are diagrams illustrating an example of archive log AL of the transaction. In FIG. 2 A and FIG. 2B, the archive log AL indicates an execution history of the transaction having two SQL commands. In an example of FIG. 2 A and FIG. 2B, the SQL command 2 is a SQL command to follow the SQL command 1.

The archive log AL has the execution history of each SQL command included in the transaction. For example, the execution history has the data which an SQL command updates, quantity of the update record, the information of the execution result (normal end/abnormal end) of the SQL command. In addition, the execution history has page information or the address information in the page in the database 105 that an SQL command is targeted for update.

FIG. 2A indicates the archive log AL of the transaction which finished normalcy. In other words, FIG. 2A indicates the archive log AL of the transaction that update was established by the COMMIT command after the SQL commands 1, 2. Therefore, the archive log AL has the execution history of the COMMIT command in addition to execution histories of SQL command 1, 2.

For example, the transaction finishes normalcy even if one of SQL command 1, 2 included in the transaction is terminated abnormally according to a slight error. For example, the slight error indicates the statement error of the SQL command. On the other hand, when a serious error occurs during execution of the transaction, the ROLLBACK command is executed, and the transaction is terminated abnormally.

The serious error is, for example, abnormal termination of the SQL command included in the transaction caused by lack of memory and cutting of the communication with the database 105. Or the serious error indicates update of data for the access of the transaction by other transaction.

FIG. 2B indicates the archive log AL of the transaction terminated abnormally. When the ROLLBACK command is executed, the database management system returns the update by each SQL command included in the transaction to a state before the update.

Particularly, the database management system copies the data that the each SQL command targets for the access at a start time of the transaction and maintains it. And when the ROLLBACK command is executed, the database management system restores the contents of the database in a original state before transaction is carried out based on the data which is maintained.

In FIG. 2B, the archive log AL indicates archive log AL of the transaction that the ROLLBACK command was executed after the SQL command 1, 2. Therefore, the archive log AL depicted in FIG. 2B has the execution history of the ROLLBACK command in addition to an execution history of SQL command 1, 2.

As described in FIG. 2A and FIG. 2B, the archive log AL of the transaction which finished normalcy includes the execution history of the COMMIT command. And the archive log AL of the transaction terminated abnormally includes the execution history of the ROLLBACK command. The archive log AL includes an execution history of the operation terminated abnormally because the archive log has the role as the trace information of the operation.

### Flow of the Reconstruction Processing

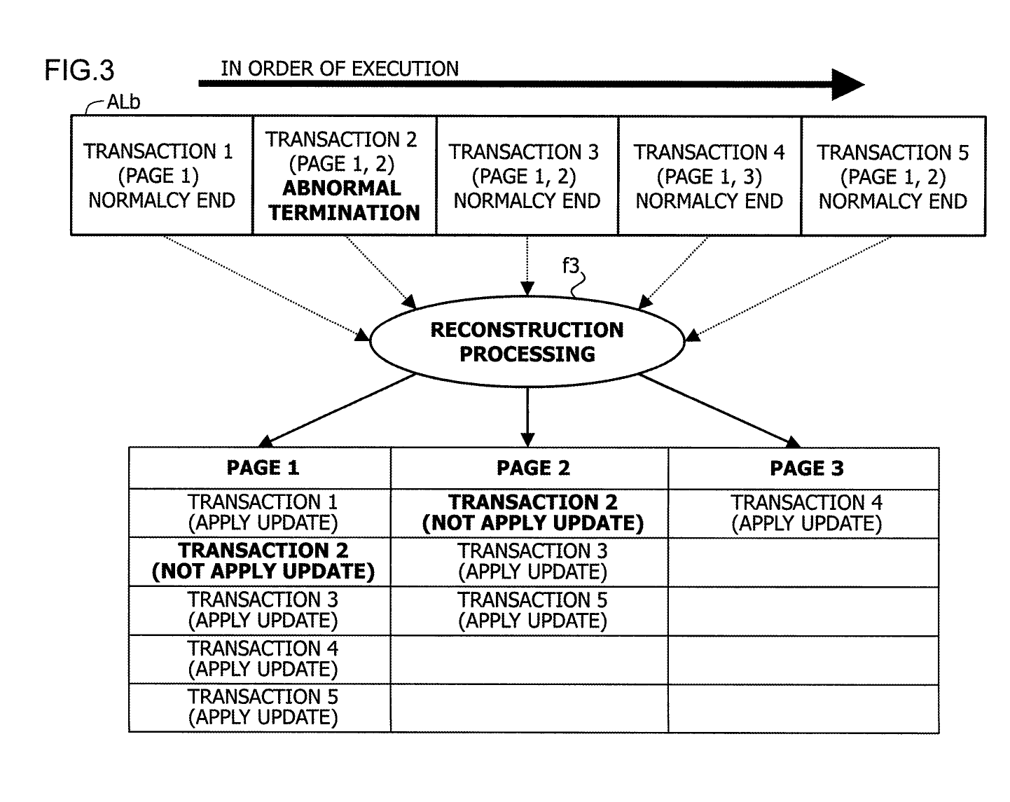

FIG. 3 is a diagram explaining a flow of reconstruction processing f3 which is indicated in FIG. 1 schematically. In FIG. 3, the archive backup log ALb is archive backup log ALb when the transaction was carried out in order of transaction 1, transaction 2, and transaction 3.

As mentioned in FIG. 1, the database management system restores contents of the database 105B at the time “tB” based on the DB backup file 105Ab (referring to FIG. 1) and the archive backup log ALb (referring to FIG. 1) as the reconstruction processing f3.

As mentioned above, at first, the database management system, as reconstruction processing f3, restores the database 105A at the time “tA” based on the DB backup file 105Ab (referring to FIG. 1). And the database management system reconstructs contents of the database 105B at the time “tB” by applying an execution history of the transactions 1-5 included in the archive backup log ALb in execution order.

Specially, the database management system acquires an execution history of the transaction 1 with reference to the archive backup log ALb and determines whether the transaction 1 finished normalcy. The transaction 1 in the example of FIG. 3 indicates the transaction of which the execution history has the COMMIT command, and the transaction which terminated normalcy.

In addition, the database management system judges whether each of the SQL command included in the transaction 1 finished normalcy. The database management system applies the update of the SQL command that normalcy finished to the database 105A which is restored. The transaction 1 performs update for page one of the database 105A. Therefore, the database management system applies the update of the transaction 1 to the page one of the database 105A.

Then, the database management system acquires the execution history of transaction 2, and judges whether the transaction 2 finished normalcy. The transaction 2 in the example of FIG. 3 indicated the transaction of which the execution history has the ROLLBACK command, and the transaction which terminated abnormally. Therefore, the database management system does not apply the update of the transaction 2 to page 1 and 2 in the database 105A.

Similarly, the database management system acquires the execution history of transaction 3, and judges that the transaction 3 is a transaction which finished normalcy. When each SQL command included in the transaction 3 finishes normalcy, the database management system applies the update of transaction 3 to page 1 or 2 in the database 105A. Similarly, the database management system applies the update of transaction 4 to the page 1 and 3 and applies the update of transaction 5 to 1 one and 2.

In this way, the database management system judges whether the transaction which is executed finished normalcy with reference to the archive backup log ALb. In addition, the database management system judges whether an SQL command included in the transaction finished normalcy when the transaction is finished normalcy. And the database management system applies the update by the SQL command which normalcy finished to the database 105A which is restored.

When a large number of operations is carried out, the size of the archive log AL and the archive backup log ALb increases. A large-capacity area is in this way needed to memorize the archive backup log ALb which was backed up and was formed. Therefore, cost increases and there may suppress a domain to memorize the database 105.

In addition, the archive backup log ALb includes an execution history of the transaction terminated abnormally and the execution history of the SQL command terminated abnormally. In other words, the archive backup log ALb has an execution history not to use for reconstruction processing.

Therefore, the database management system, in the case of reconstruction processing, determines whether the transaction corresponding to the execution history is a transaction finished normalcy one by one. In addition, the database management system has to judge whether each SQL command included in the transaction that finished normalcy, finished normalcy.

Therefore, the speed of the reconstruction processing may not raise up. When a failure of database 105 occurs, it is desirable for reconstruction processing to be completed immediately.

### Summary of Embodiment

Therefore, the control program according to the embodiment, when backing up operation execution log, which is memorized depending on operation carried out for a second memory region, in the first memory region to the third memory region, selects the operation execution log and memorizes it in the third memory region. Especially, the control program selects operation execution log of the operation finished normally among the operation execution log memorized in the first memory region and memorizes it in the third memory region.

Because the third memory region memorizes only operation execution log of the operation finished normally, it is possible to reduce the capacity of the stored operation execution log in the third memory region. Thereby, it is possible to reduce memory capacity needed for backup of the operation execution log and to suppress the cost.

In addition, when the control program restores a second memory region based on the operation execution log memorized in the third memory region, the control program does not have to judge whether each memorized operation execution log is operation execution log of the operation that was finished normally (namely, should apply to the second memory region). Therefore, it is possible that the control program performs the reconstruction processing effectively only based on operation execution log of the operation finished normally.

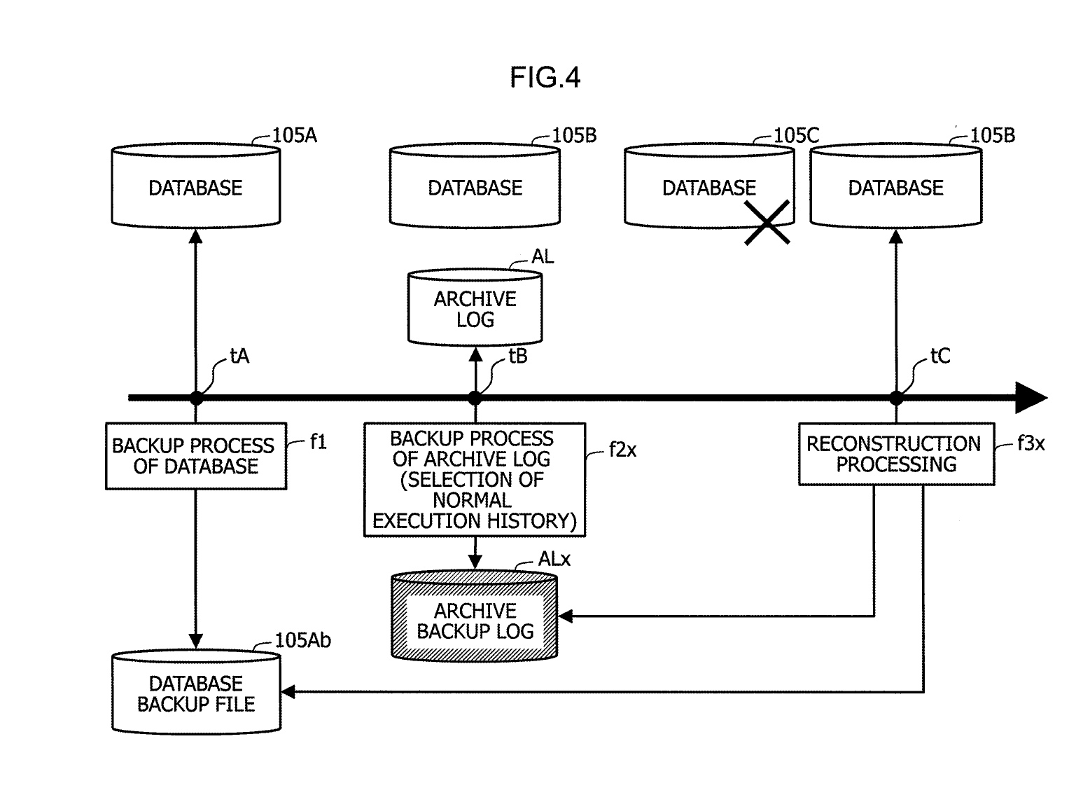

For example, the first, second, and third memory regions are constructed by an auxiliary memory or a storage device of the information processing device. The first, second, and third memory units may be the same area. The second memory region memorizes the database 105 which is indicated in FIG. 1 and the operation execution log indicates the archive log AL depicted in FIG. 1. Then, according to a flow chart of FIG. 4, the processing of the control program in the embodiment when the database 105 is memorized in the second memory region will be explained.

### Backup Processing of the Embodiment

FIG. 4 is a diagram explaining a summary of the backup processing of archive log AL by the control program according to the embodiment schematically. In FIG. 4, same elements as that in FIG. 1 are marked as same sign indicated in FIG. 1. The processing at the time “tA” is same as that in FIG. 1, thereby the processing of the time “tA” is omitted.

(at time “tB”)

At the time “tB”, the control program of the embodiment carries out backup processing f2x of the archive log AL. In this time, the control program in the embodiment selects an execution history of the operation that normalcy finished among the execution histories included in the archive log AL and memorizes in the archive backup log ALx (indicated by slanted line).

Therefore, the archive backup log ALx generated according to the backup processing f2x has only an execution history of the operation finished normally among the execution histories of the operation carried out from the time “tA” to the time “tB”. The operation that processing finished normalcy indicates an operation reflected to the database 105.

When the archive backup log ALx is information for reconstruction processing, the execution history of the operation terminated abnormally may not be needed. Therefore, the archive backup log ALx has not an execution history of the operation that finished abnormally and was not reflected to the database 105 among the execution histories of the operation carried out between the time “tA” and the time “tB”. Therefore, it is possible to reduce capacity of the archive backup log ALx and to reduce the cost of storage for memorizing the archive backup log ALxs. In addition, it is possible to avoid suppressing an area of the database 105.

On the other hand, the archive log AL has an execution history of all operation carried out between the time “tA” and the time “tB”. In other words, the database management system, when memorizing an execution history of the operation depending on execution in the archive log AL, does not judge whether the transaction is an execution history of the operation finished normally. In other words, in the embodiment, the control program, in the case of backup, selects the execution history without selecting the execution history at the time of the normal operation. Thereby, it is possible to control a drop of the transaction speed by selecting the execution history at the time of normal operation.

(at time “tC”)

When a failure occurs, the control program restores the contents of the database at the time “tB”, based on the DB backup file 105Ab and the archive backup log ALx.

As described above, the archive backup log ALx in the embodiment has only an execution history of the operation that normalcy finished. Therefore, it is possible that the control program performs the reconstruction processing without judging whether each execution history included in the archive backup log ALx is an execution history of the operation reflected to the database 105A one by one. Thereby, it is possible that the control program carries out the reconstruction processing fast.

In addition, the control program in the embodiment does not select the execution history at the time of reconstruction processing, but selects the execution history beforehand at the time of backup. Thereby, it is possible to control a drop of the transaction speed by selecting the execution history at the reconstruction processing.

In this way, the control program in the embodiment performs the extraction processing of the execution history of the operation that normalcy finished at the backup of the archive log AL. Thereby, it is possible to restrain a drop of the transaction speed by extracting the execution history at the time of normal operation and reconstruction processing while shortening the processing time to need for the reconstruction.

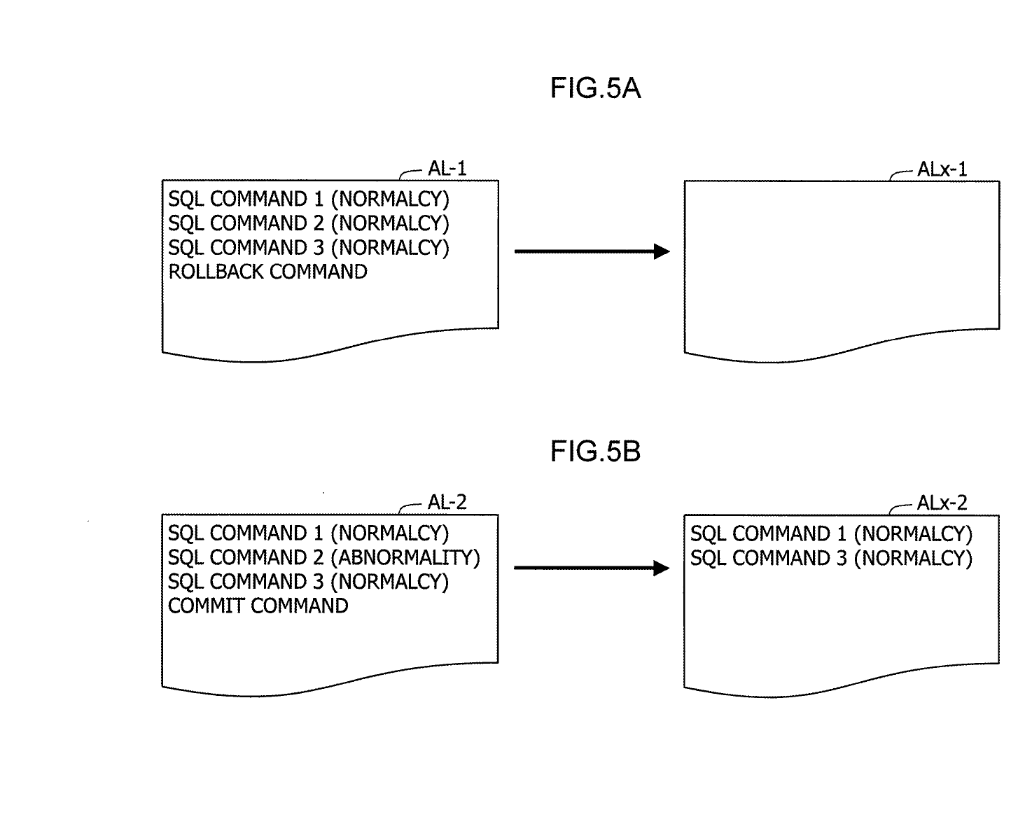

Then, according to FIG. 5, an example of the operation that normalcy finished will be explained.

### Execution History of Operation that Normalcy Finished

FIG. 5A and FIG. 5B are diagrams explaining an example of the execution history of the operation that normalcy finished. FIG. 5A and FIG. 5B indicate examples of the archive backup log ALx which is generated by back up of the archive log AL.

The archive log AL-1 depicted in FIG. 5A is a transaction including three SQL commands and indicating an execution history of the transaction terminated abnormally according to the ROLLBACK command. When the transaction is terminated abnormally, each SQL command is considered to have been terminated abnormally. Therefore, the archive backup log ALx-1 depicted in FIG. 5A does not have the execution history of either of SQL commands (operation).

The archive log AL-2 depicted in FIG. 5B is a transaction including three SQL commands and indicating an execution history of the transaction which finished normalcy according to the COMMIT command. In addition, the archive log AL-2 indicates an execution history when the second SQL command was terminated abnormally due to a statement error among three SQL commands. Therefore, the archive backup log ALx-2 depicted in FIG. 5B has only execution histories only for the first and third SQL commands (operations).

In this way, the archive backup log ALx in the embodiment has the execution history of the SQL commands that finished normally as an execution history of the operation.

A large amount of the statement errors of the SQL command may occur depending on the description technique of the SQL command. Here, an example of the description technique of the SQL command that a statement error may produce will be explained. A description example of the SQL command of the program, which performs update processing in the presence of a record matching with a predetermined condition and performs addition process when a record to be matched does not exist, will be explained.

According to a first description example, the program has a description (1) of SQL command “SELECT” which searches a record to match with a predetermined condition. In addition, the program has a description (2) of SQL command “INSERT” which adds a record when an execution result of SQL command “SELECT” is 0 number and a description (3) of SQL command “UPDATE” which updates a record when the execution result is more than one. Therefore, the program performs two SQL commands “SELECT” and “UPDATE” when the execution result of SQL command “SELECT” is more than one.

According to a second description example, the program has a description (1) of SQL command “UPDATE” which updates a record and a description (2) of SQL command “INSERT” which adds a record when the SQL command “UPDATE” is terminated abnormally. The case that the SQL command “UPDATE” is terminated abnormally corresponds to the case that the execution result of SQL command “SELECT” in the first description example is 0 cases.

According to the second description example, when the SQL command “UPDATE” finishes normalcy (equivalent when the execution result is more than one), the program carries out only SQL command “UPDATE”. In other words, according to the second description example, it is possible that the program omits a step to carry out the SQL command “SELECT” when the SQL command “UPDATE” finishes normalcy. Therefore, the number of SQL commands to execute decreases, and processing performance improves.

But, according to the second description example, when a record to match with a predetermined condition does not exist SQL, the command “UPDATE” is terminated abnormally, and a statement error occurs. When a program includes a large number of the description such as the second description example, a large quantity of statement may error. In this case the archive log AL includes the large number of execution history of the SQL command terminated abnormally. Therefore, the size of archive backup log ALx may be largely reduced by selecting an execution history of the operation that normalcy finished.

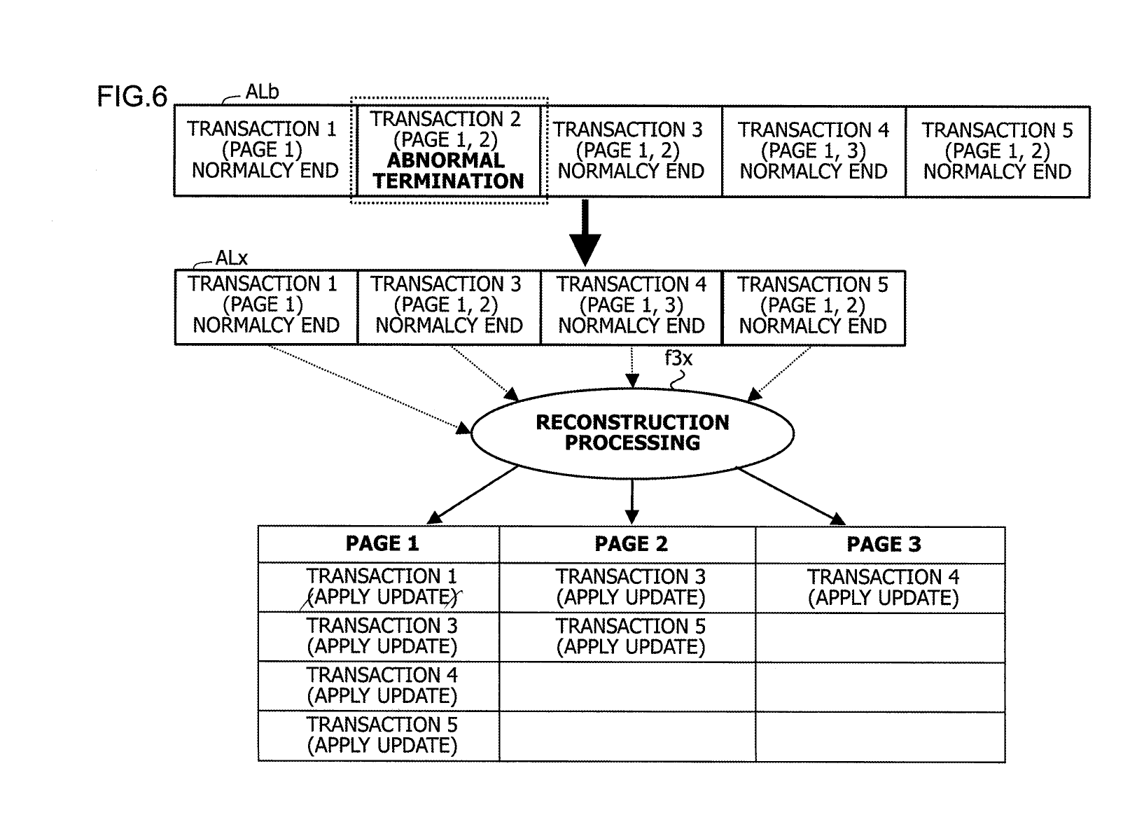

Then, according to FIG. 6, a summary of the reconstruction processing based on archive backup log ALx in the embodiment will be explained.

### Flow of Reconstruction Processing based on Archive Backup Log ALx

FIG. 6 is a diagram explaining a flow of reconstruction processing f3x (referring to FIG. 4) based on the archive backup log ALx schematically. In FIG. 6, same elements as that in FIG. 3 are represented by same signs indicated in FIG. 3.

As illustrated in FIG. 4A, FIG. 4B and FIG. 5, the control program in the embodiment selects execution histories of the transaction 1, 3-5 which finished normally and memorizes it as the archive backup log ALx. Therefore, the archive backup log ALx depicted in FIG. 6 includes execution histories except an execution history of the transaction 2 which terminated abnormally.

When a failure occurs in the database 105B, the control program restores the database 105B based on the DB backup file 105Ab (referring to FIG. 4A) and the archive backup log ALx as the reconstruction processing f3x.

The archive backup log ALx in the embodiment has only an execution history of the operation that finished normally. Therefore, the control program applies update of the transactions 1, 3-5 to the corresponding page without judging whether the execution history which is read is an execution history which finished normally one by one during the reconstruction processing. Thereby, it is possible that the control program carries out the reconstruction processing fast.

In addition, in FIG. 4A, FIG. 4B, FIG. 5A, FIG. 5B and FIG. 6, it is exemplified that the second memory unit memorized the database 105, and the operation execution log is the archive log AL depicted in FIG. 1. But it is not a thing limited to this example. For example, in the second memory unit, file system and data group of other form may be memorized. In this case the operation log indicates execution log generated depending on operation such as the file system and other forms of data group.

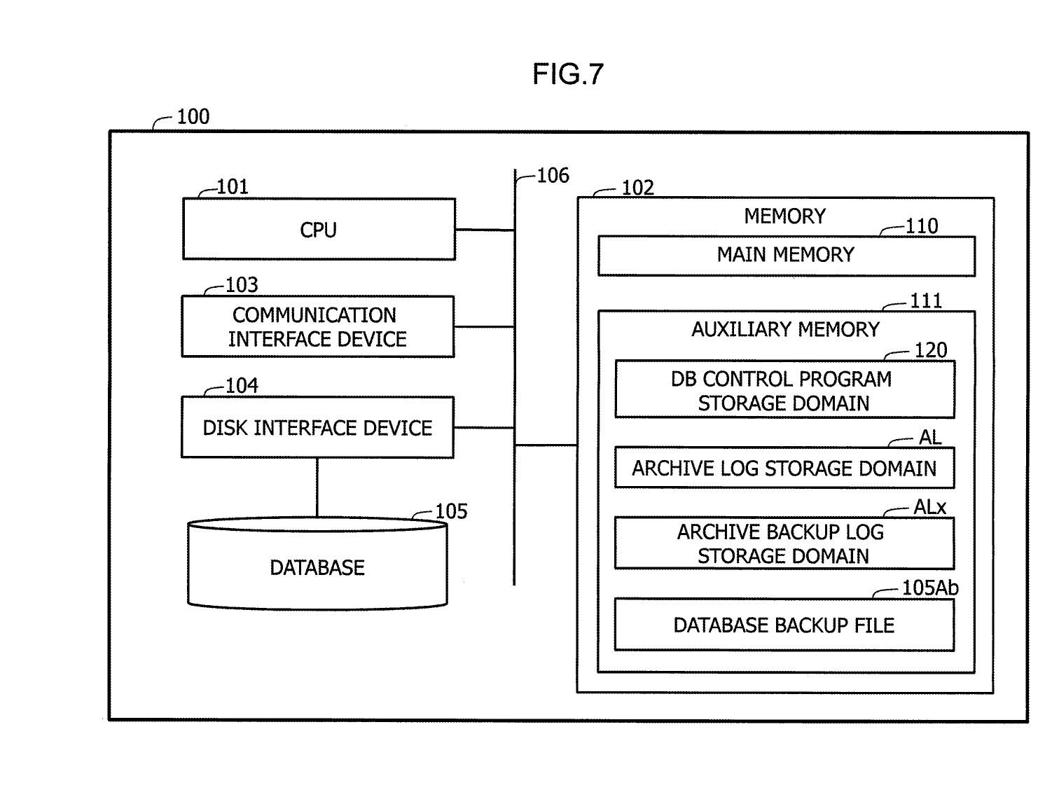

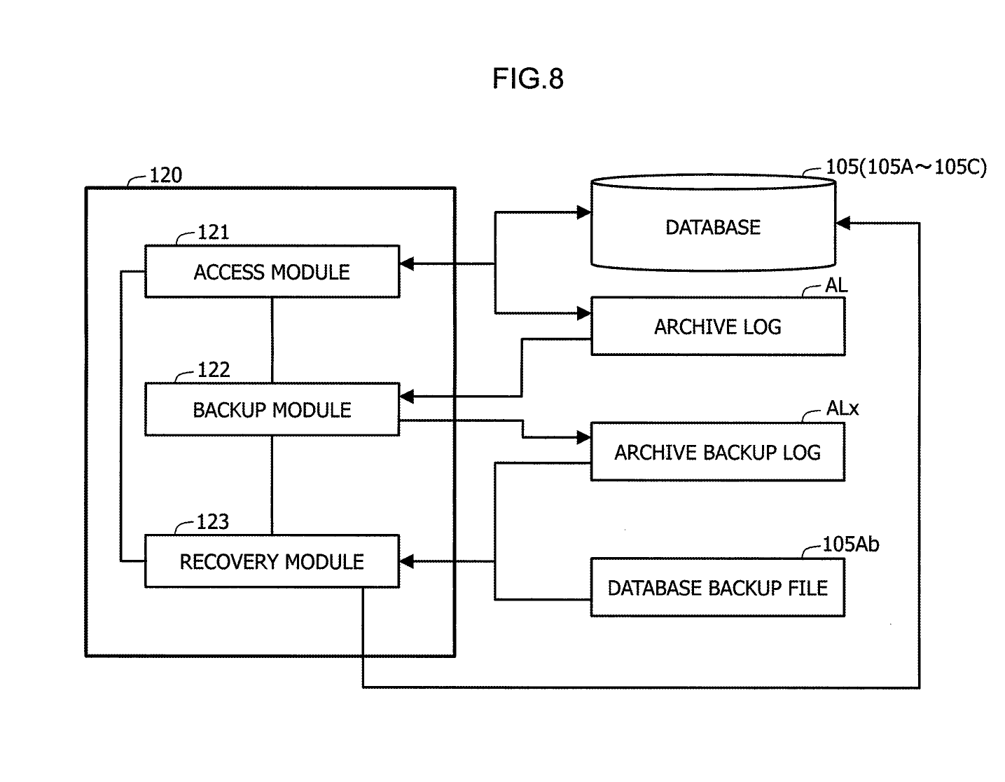

Then, according to FIG. 7, the hardware constitution of the information processing device in the embodiment will be explained. And the software block diagram of the information processing device in the embodiment will be explained according to FIG. 8.

### Hardware Constitution of the Information Processing Device

FIG. 7 is a diagram of hardware constitution of information processing device 100 in the embodiment. For example, the information processing device 100 has a CPU (Central Processing a) 101, a memory 102 including a main memory 110 and an auxiliary memory 111, etc., a communication interface device 103, a disk interface device 104, and a database 105. The all parts are connected through a bus 106 mutually.

The CPU 101 is connected to the memory 102 etc. through the bus 106 and controls the whole information processing device 100. The communication interface device 103 connects with other devices (not illustrated in FIG. 7) and transmits and receives data. The main memory 110 including a RAM (Random Access Memory) memorizes the data which the CPU 101 processes.

The auxiliary memory 111 has domain (not illustrated in FIG. 7) storing the program of the operation system that the CPU 101 carries out and DB control program storage domain 110. In addition, the auxiliary memory 111 further has an archive log storage domain AL, an archive backup log storage domain ALx, a DB backup file storage domain 105Ab. The auxiliary memory 111 includes a HDD (Hard disk drive) and a nonvolatile semiconductor memory.

The DB control program (called as DB control program 120 as follows) in the DB control program storage domain 120 is a control program and realizes processing of database management system (called as DBMS) by execution of CPU 101. For example, the processing of the DBMS includes a control processing of the access for the database 105 and management processing of the database 105.

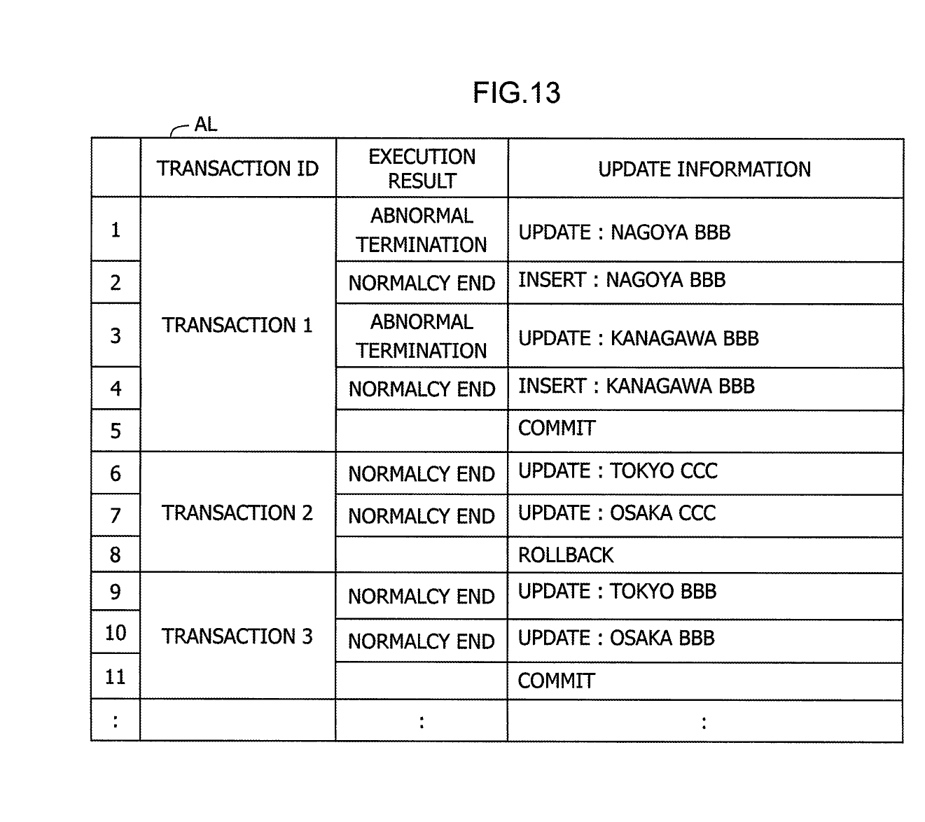

The archive log (below called as archive log AL) in the archive log storage domain AL is information indicating the execution history of the operation for the database 105. The details of the archive log AL will be mentioned later according to FIG. 13.

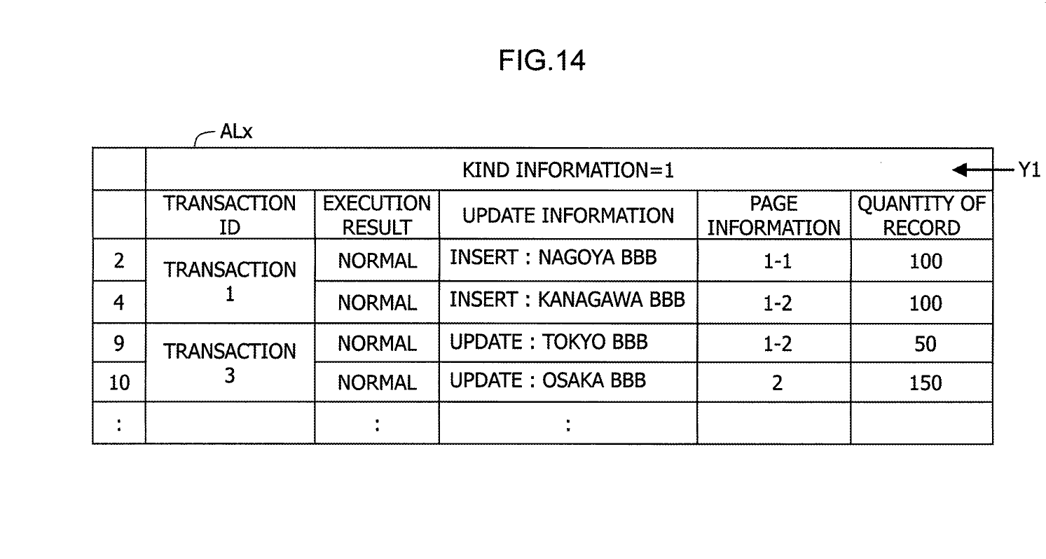

The archive backup log (below called as archive backup log ALx) in the archive backup log storage domain ALx is information which is formed by backing up the archive log AL. The details of the archive backup log ALx will be mentioned later according to FIG. 14.

The DB backup file (below called as DB backup file 105Ab) in the DB backup file storage domain 105Ab is information which is formed by backing up the database 105A.

### Software Block Diagram of the Information Processing Device

FIG. 8 is a diagram of constitution of the software block of information processing device 100 in FIG. 7. As depicted in FIG. 8, for example, the DB control program 120 (referring to FIG. 7, control program) includes an access module 121, a backup module 122, and a recovery module 123.

The access module 121 performs an access for the database 105 by executing the SQL command. In addition, the access module 121 generates the archive log AL depending on operation for the database 105.

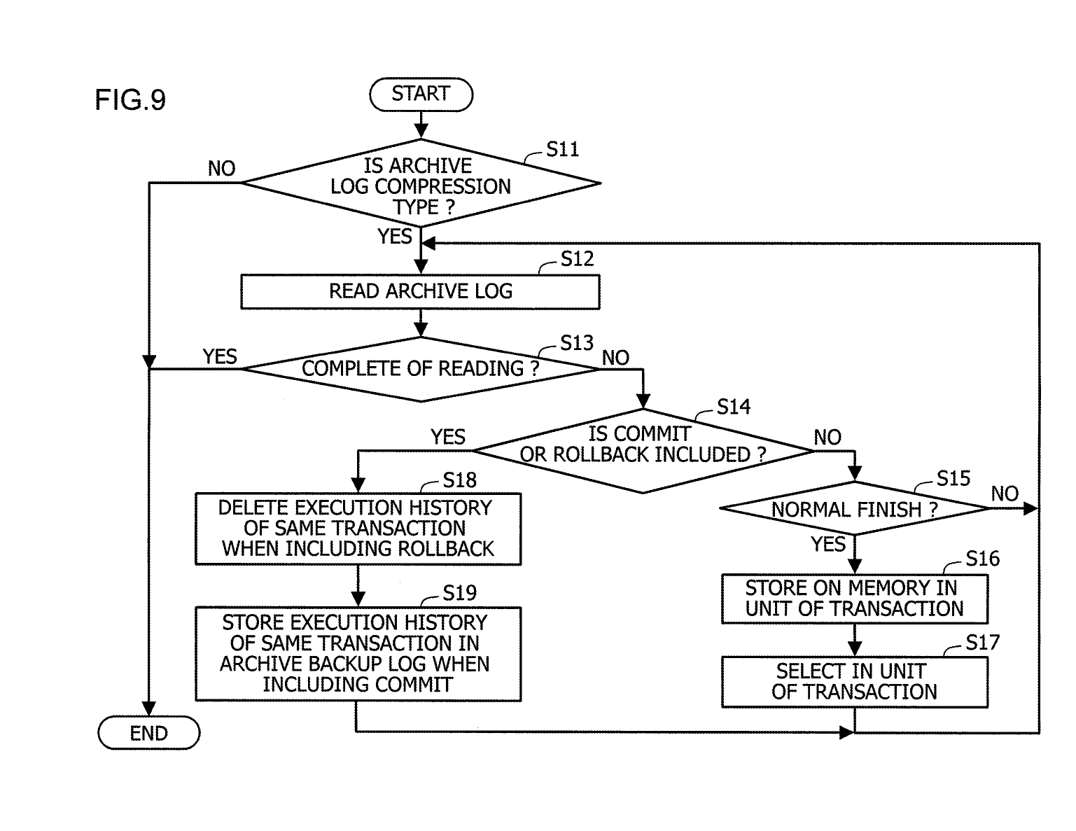

The backup module 122, depending on the instructions of backing up the archive log AL, selects an execution history of the operation which finished normally and memorizes it in the archive backup log ALx. The details of the processing of the backup module 122 will be mentioned later according to a flow chart of FIG. 9. In addition, not illustrated, but the backup module 122 backs up the database 105 and generates the DB backup file 105Ab.

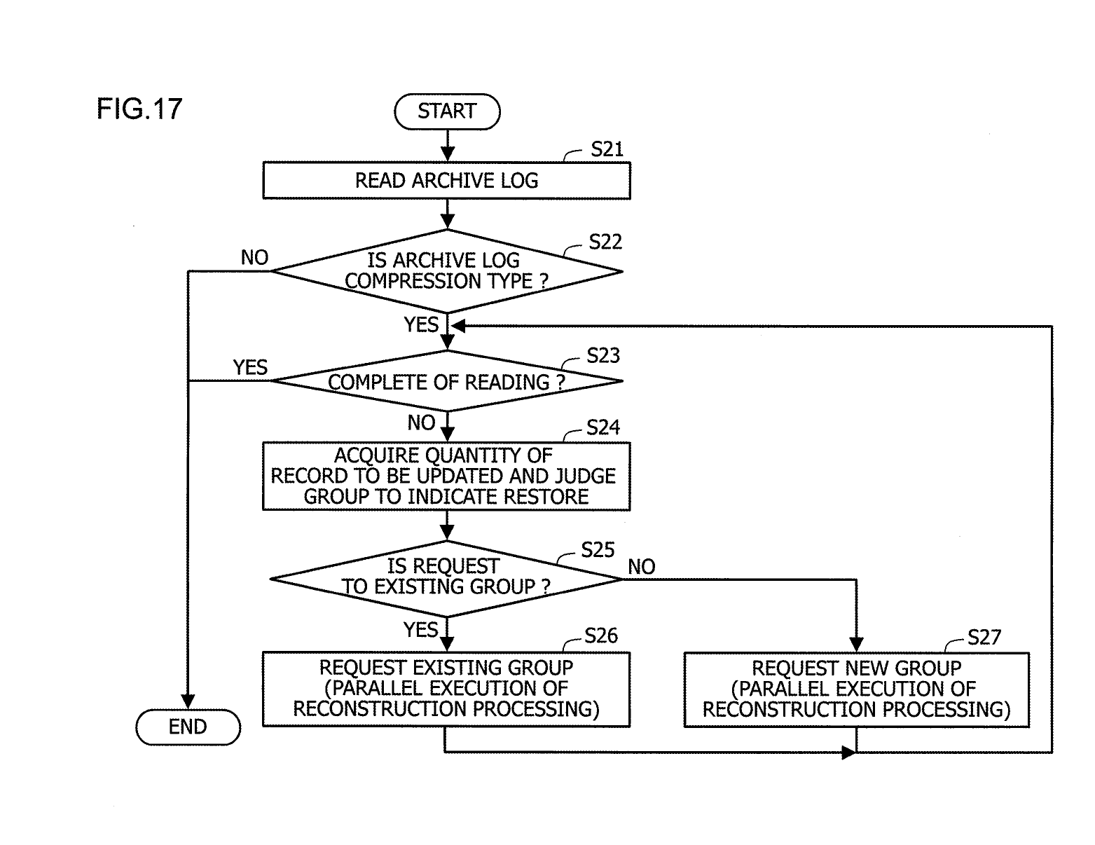

The recovery module 123, depending on reconstruction instructions of database 105 at the time of failure outbreak, restores contents of the database 105 based on the DB backup file 105Ab and the archive backup log ALx. The details of the processing of recovery module 123 will be mentioned later according to a flow chart of FIG. 17.

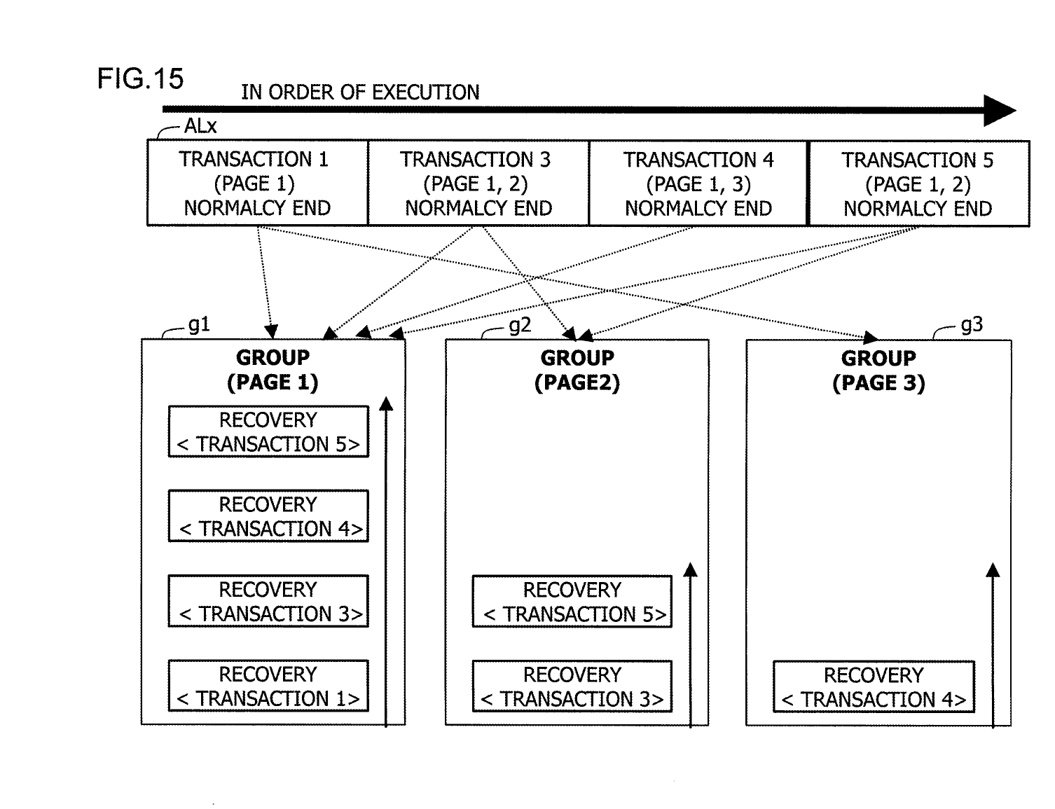

Then, the processing of the backup module 122 in the DB control program 120 depicted in FIG. 8 will be mentioned according to FIG. 9-FIG. 14. In addition, the processing of the recovery module 123 in the DB control program 120 depicted in FIG. 8 will be mentioned according to FIG. 15-FIG. 19.

### Flow of Processing of Backup Module 122

FIG. 9 is a diagram of flow chart explaining a flow of the processing of backup module 122 in DB control program 120 depicted in FIG. 8.

The backup module 122 carries out backup processing depicted in the flow chart of FIG. 9 in response to a backup demand of the archive log AL. For example, the backup module 122 carries out the backup processing depending on input of the command “rdblog-B {archive backup log name}-COMP” into the user interface of information processing device 100.

S11: The backup module 122 judges whether the compression instruction “-COMP” of the archive log AL was appointed in the backup demand. When the compression instructions are not appointed (No of S11), the backup module 122 finishes backup processing.

S12: On the other hand, when the compression instruction is appointed (Yes of S11), the backup module 122 reads the archive log AL.

S13: The backup module 122 judges whether read all execution histories from the archive log AL. When the backup module 122 reads all execution histories (Yes of S13), the backup module 122 finishes processing.

S14: When there is the execution history which is not read (No of S13), the backup module 122 judges whether the execution history which is read from the archive log AL includes the COMMIT command or the ROLLBACK command.

S15: When the execution history does not include the COMMIT command or the ROLLBACK command (No of S14), the execution history which is read indicates the case that is the execution history of the SQL command. In other words, the backup module 122 judges whether the execution history of the SQL command which is read is the execution history of the SQL command which finished normally.

S16: When the execution history is an execution history of the SQL command which finished normally (Yes of S15), the backup module 122 memorizes the execution history concerned to a transaction unit in the memory 110 (referring to FIG. 7). On the other hand, when the execution history is an execution history of the SQL command terminated abnormally (No of S15), the backup module 122 does not memorize the execution history concerned in the memory 110. In other words, the backup module 122 does not memorize the execution history of the SQL command terminated abnormally in the archive backup log ALx.

S17: The backup module 122 classifies the execution histories which are held in the memory 110 in every transaction. And the backup module 122 changes for processing of process S12 and begins to read a new execution history from the archive log AL.

S18: When the execution history includes the ROLLBACK command (Yes of S14), the execution history concerned indicates that it is an execution history of the transaction terminated abnormally. Therefore, the backup module 122 discards the execution history of the transaction including the ROLLBACK command from the memory 110.

S19: On the other hand, when an execution history includes COMMIT command (Yes of S14), the execution history indicates an execution history of the transaction which finished normally. Therefore, the backup module 122 memorizes an execution history of the transaction including the COMMIT command which is memorized in the memory 110 as the archive backup log ALx.

In addition, in this time, the backup module 122 adds information about the update of each SQL command to the execution history and memorizes it in the archive backup log ALx. Especially, the backup module 122 acquires page information and quantity of record for update target of database 105 that an SQL command intends for and memorizes it in the archive backup log ALx.

In this way, in the embodiment, the operation has the operation for the database memorized in the second memory unit, and the operation finished normally has operation reflected to the database. In other words, the backup module 122 selects the operation execution log (execution history) of the operation reflected to database 105 among the operation execution logs (archive log AL) memorized in the first memory unit and memorizes it in the archive backup log ALx. Thereby, it is possible to generate the archive backup log ALx having only execution histories of the operation reflected to the database 105.

In addition, in the embodiment, the operation reflected to the database 105 is a series of operation group for the database 105 (transaction), and is an operation that the COMMIT command which establishes the update of the operation group is carried out.

Thereby, it is possible that the backup module 122 generates the archive backup log ALx having the execution history of the SQL command of the transaction that the update was established by the COMMIT command. In other words, it is possible that the backup module 122 generates the archive backup log ALx which is excluded the execution history of the SQL command of the transaction that the update was canceled by the ROLLBACK command.

In addition, the operation which is reflected to the database 105 in the embodiment indicates an operation (SQL command) which finished normally among the operation (SQL command) included in the operation group (transaction) that the COMITT command was carried out. Thereby, it is possible that the backup module 122 generates the archive backup log ALx having the execution history of the SQL command reflected to the database 105 among execution histories of the transaction which finished normalcy.

### Embodiment

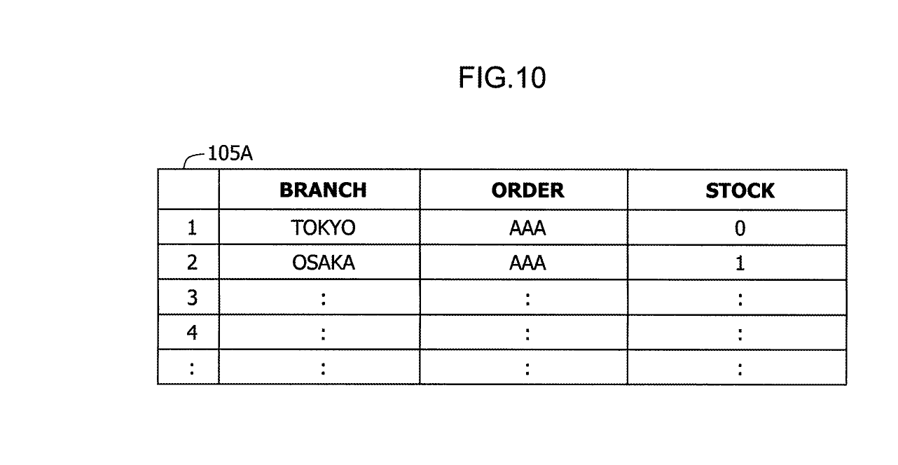

Then, embodiments of the processing of backup module 122 which illustrated by a flow chart of FIG. 9 will be explained according to FIG. 10-FIG. 14.

(database 105A at time “tA”)

FIG. 10 is a diagram indicating an example of database 105A at the time “tA”. The database 105A depicted in FIG. 10 indicates a simple example for explanation of the embodiment. For example, the database 105A has a large quantity of records for the database 105A depicted in FIG. 10.

In FIG. 10, the database has information of item “branch”, item “order” and an item “stock”, for example. The database depicted in FIG. 10 has the information of two records. A first record has a branch “Tokyo”, an order

“AAA” and a stock “0”. In addition, a second record has a branch “Osaka”, an order “AAA” and a stock “1”.

(transaction carried out from time “tA” to time “tB”)

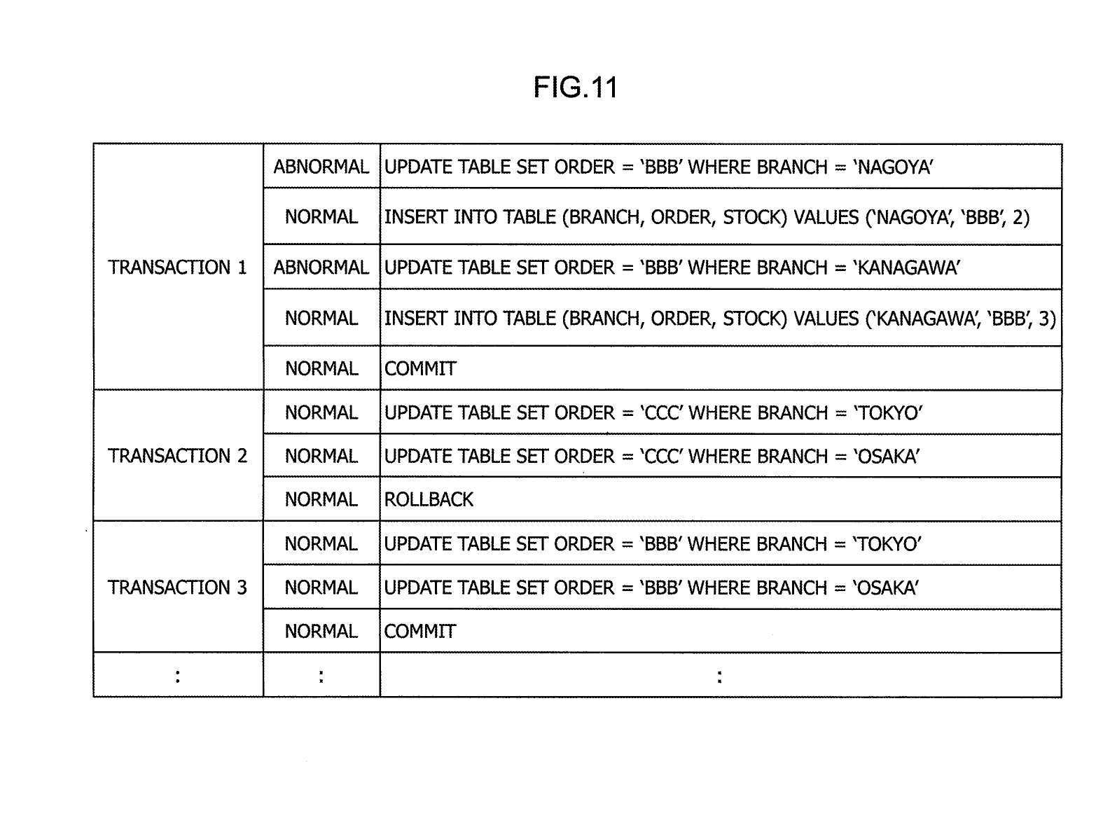

FIG. 11 is a diagram indicating an example of the transaction carried out for database 105A (FIG. 10) from time “tA” to time “tB”. In an example of FIG. 11, the access module 121 carries out transaction in order of transaction 1, transaction 2, transaction 3 sequentially.

The transaction 1 includes four SQL commands and finishes normalcy. In addition, among four SQL commands that transaction 1 has, two SQL commands are terminated abnormally.

The first SQL command “UPDATE table SET order=‘BBB’ WHERE branch=‘Nagoya’” in the transaction 1 indicates a command to update the item “order” of the record of the branch “Nagoya” in value “BBB”. Because the database 105A in FIG. 10 does not have a record of branch “Nagoya”, the first SQL command is terminated abnormally. In addition, the second SQL command “INSERT INTO table (branch, order, stock) VALUES (‘Nagoya’, ‘BBB’, 2),” indicates a command to add a record of branch “Nagoya”, order “BBB”, and stock “2” and finishes normalcy.

In addition, the third SQL command “UPDATE table SET order=‘BBB’ WHERE Branch=‘Kanagawa’” indicates a command to update the item “order” of the record of branch “Kanagawa” in value “BBB”. Because the database 105A in FIG. 10 does not have a record of branch “Kanagawa”, the third SQL command is terminated abnormally. The fourth SQL command “INSERT INTO table (branch, commanding, stock) VALUES (‘Kanagawa’, ‘BBB’, “3”)” indicates a command to add a record of branch “Kanagawa”, order “BBB” and stock “3” and finished normally.

The transaction 2 includes two SQL commands and is terminated abnormally according to the ROLLBACK command. The first SQL command “UPDATE table SET order=‘CCC’ WHERE Branch=‘Tokyo’” in the transaction 2 indicates a command to update the item “order” of the record of the branch “Tokyo” in value “CCC”. In addition, the second SQL command “UPDATE table SET commanding=‘CCC’ WHERE Branch=‘Osaka’” indicates a command to update the item “order” of the record of branch “Osaka” in value “CCC”.

The transaction 3 includes two SQL commands and finishes normalcy. The first SQL command “UPDATE table SET order=‘ BBB’ WHERE Branch=‘Tokyo’” in the transaction 3 indicates a command which updates the item “order” of the record of branch “Tokyo” in value “BBB” and finishes normalcy. The second SQL command “UPDATE table SET order=‘BBB’ WHERE Branch=‘Osaka’” indicates a command which updates the item “order” of the record of branch “Osaka” in value “BBB” and finishes normalcy.

(database 105B at time tB)

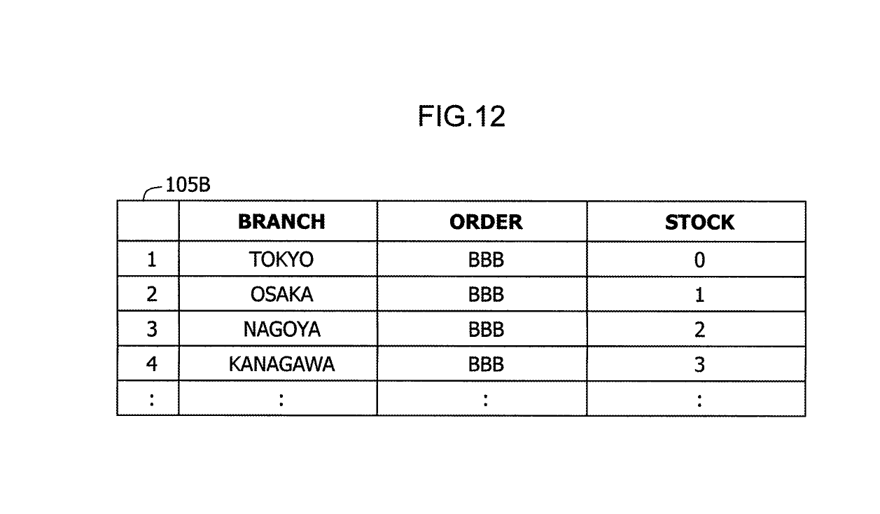

FIG. 12 is a diagram indicating database 105B at time tB which was updated by executing the transaction depicted in FIG. 11. As illustrated by FIG. 11, the second and fourth SQL commands among the SQL commands in the transaction 1 finish normalcy. Therefore, the database 105B depicted in FIG. 12 includes a record of branch “Nagoya” and “Kanagawa”. In addition, two SQL commands in the transaction 3 finish normalcy. Therefore, the database 105B depicted in FIG. 12 includes a record of branch “Tokyo” and branch “Osaka” having value “BBB” for item “order”.

(archive log AL)

FIG. 13 is a diagram indicating an example of archive log AL which was generated when the transaction depicted in FIG. 11 is carried out. The archive log AL depicted in FIG. 13, includes information of an item “transaction ID”, an item “execution result” and an item “update information”.

The execution histories of item number “1” . . . item number “5” depicted in FIG. 13 indicate execution histories of the transaction 1. The execution history of the item number “1” indicates the execution history of the first SQL command and includes the information of the transaction ID “1”, update information “UPDATE: Nagoya BBB” and information of the execution result “abnormal termination”. In addition, FIG. 13 exemplifies simple information as update information, but the update information includes data for the update and the positional information of the record for the update.

Similarly, the execution history of item number “2” indicates the execution history of the second SQL command, and includes the information of the transaction ID “1”, update information “INSERT: Nagoya BBB” and information of the execution result “normalcy end”. Similarly, the execution history of item number “3” and “4” indicate the execution history of the third and fourth SQL commands in the transaction 1. In addition, the execution history of item number “5” indicates the execution history of the COMMIT command to establish update of the transaction 1.

In addition, the execution histories of item number “6” . . . item number “8” depicted in FIG. 13 indicate execution histories of the transaction 2.

The execution histories of item number “6” and “7” indicates the execution history of each SQL command included in the transaction 2. In addition, the execution history of item number “8” indicates the execution history of the ROLLBACK command to cancel the update of the transaction 2. Similarly, the execution histories of item number “9” . . . item number “11” depicted in FIG. 13 indicate execution histories of transaction 3.

(archive backup log ALx)

FIG. 14 is a diagram indicating an example of archive backup log ALx formed according to backup processing of archive log AL depicted in FIG. 13.

For example, the archive backup log ALx in the embodiment may have information “KIND=1” indicating that the log is archive backup log ALx for compression, as indicated by an arrow Y1 of FIG. 14. For example, when the log has information “KIND=0”, the archive backup log ALb is a log of non-compression (FIG. 1).

The archive backup log ALx depicted in FIG. 14, includes, for example, information of item “transaction ID”, item “execution result”, item “update information”, item “page information” and item “quantity of record”. The item “page information” indicates a page for the update, and the item “quantity of record” indicates quantity of record for the update.

(transaction 1)

The backup module 122 reads the execution history of item number “1” from the archive log AL (S12 of FIG. 9). The execution history of item number “1” does not include the COMMIT command and the ROLLBACK command (No of S14). In addition, because the execution history of item number “1” indicates the execution history of the SQL command terminated abnormally according to the item “execution result” (No of S15), the backup module 122 does not memorize an execution history of item number “1” in the memory 110.

The backup module 122 reads an execution history of item number “2” next from the archive log AL (S12). Because the execution history of item number “2” indicates the execution history of the SQL command that the execution history of item number “2” finished normalcy (No of S14, Yes of S15), the backup module 122 memorizes an execution history of item number “2” in the memory 110 (S16). Similarly, the backup module 122 reads execution histories of item number “3” and “4” (S12), and memorizes an execution history of item number “4” in the memory 110 (S16).

Then, the backup module 122 reads an execution history of item number “5” including the COMMIT command (Yes of S14). And the backup module 122 stores execution histories of item number “5” and an execution history of item number “2” “4” that the transaction ID is same value among the execution histories which is memorized in the memory 110, in the archive backup log ALx.

Therefore, the archive backup log ALx depicted in FIG. 14 includes the execution histories of item number “2” and “4” that the SQL command finished normally among the execution histories of the SQL command included in the transaction 1. In addition, the archive backup log ALx has page information and information of the quantity of record as the execution history of each SQL command. In an example of FIG. 14, the execution history of item number “2” has information of page “1-1” and quantity of record “100” and the execution history of item number “4” has information of page information “1-2” and a quantity of record “100”.

(transaction 2)

The backup module 122 reads an execution histories of item number “6” and “7” (S12 of FIG. 9) and memorizes in the memory 110 (S16). When reading an execution history of item number “8” including the ROLLBACK command (Yes of S14), the backup module 122 deletes the information of the execution history of item number “6” and “7” where a value of the item “transaction ID” is same in the memory 110 (S18). Therefore, the archive backup log ALx depicted in FIG. 14 does not have an execution history of transaction 2.

(transaction 3)

Similarly, the backup module 122 stores the execution histories of item number “9” and “10” in the memory 110 (S16) and, when retrieving an execution history of item number “11” (Yes of S14), memorize the execution histories of item number “9” and “10” in the archive backup log ALx (S19). Therefore, the archive backup log ALx depicted in FIG. 14 has the execution histories of item number “9” and “10” of each SQL command included in the transaction 3.

### Parallel of the Reconstruction Processing

FIG. 15 is a diagram a summary of the reconstruction processing in the embodiment schematically. In FIG. 15, same elements as that in FIG. 6 are represented by same sign depicted in FIG. 6.

The recovery module 123 of the DB control program 120 depicted in FIG. 8 restores the database 105 based on operation execution log (archive backup log ALx) memorized in the third memory unit. Because the recovery module 123 does not have to judge whether the execution history included in the archive backup log is an execution history of the operation reflected to the database 105A one by one, it is possible to perform reconstruction processing with a high speed.

In addition, the recovery module 123 may classify the operation execution log (archive backup log ALx) memorized in the third memory unit in the plural groups where a target memory area of the operation does not repeat and carry out the reconstruction based on the operation execution log of plural groups in parallel. When the second memory unit memorizes the database 105, the memory area, for example, indicates and a page (later mentioned pages “1-1”, “1-2”), which is a unit of exclusive control, in the database 105.

The reconstruction processing which targets to the same area for the operation has to be performed in order of execution of the operation to evade the outbreak of inconsistence of record. On the other hand, it is possible that the reconstruction processing which targets a different area for the operation carry out in parallel. Therefore, it is possible to shorten the time needed for the reconstruction processing by classifying the execution histories included in the archive backup log ALx in the plural groups where a target area does not repeat, and carrying out the reconstruction processing of the group in parallel.

FIG. 15 is a diagram of example of a case to carry out the reconstruction processing of plural pages in parallel. The recovery module 123 generates a thread to carry out the reconstruction processing of each group g1-g3 each and carries out the reconstruction processing according to plural threads in parallel.

According to the example of FIG. 15, the first thread of recovery module 123 performs the reconstruction processing of based on the execution history group g1. In other words, the first thread applies the update of the transactions 1, 3-5 that the page 1 belonging to group g1 is a target of update. In addition, the first thread performs the restoring processing in order of the transactions 1, 3-5.

Similarly, the second thread applies the update of the transactions 3, 5 that the page 2 belonging to group g2 is targeted for update, in order of the transactions 3, 5. Similarly, the third thread applies the update of transaction 4 that the page 3 belonging to group g3 is targeted for update.

The archive backup log ALx in the embodiment has only an execution history of the operation that normalcy finished. Therefore, it is possible that the recovery module 123 classifies each execution history in group g1-g3 effectively because module 123 does not have to read each execution history and to judge whether the execution history is an execution history of the operation which finished normally. Therefore, it is possible that the recovery module 123 carries out reconstruction processing effectively.

### Classification based on the Quantity of Record

In addition, the recovery module 123 in the embodiment may classify operation execution log (archive backup log ALx) memorized in the third memory unit in the plural groups according to the quantity of target data which is restored more.

In other words, the recovery module 123 classifies the log in the group based on quantity of record for the reconstruction more so that time needed for the reconstruction processing between groups is smoothed. It is possible that the recovery module 123 shorten the processing time needed for reconstruction processing of database 105 by smoothing the processing time needed for the reconstruction processing of each group.

As mentioned above, it is preferable that the processing time needed for reconstruction processing when a failure occurred for database 105. Therefore, it is possible to minimize the influence of the failure on duties processing by shortening the processing time according to parallel processing based on quantity of record.

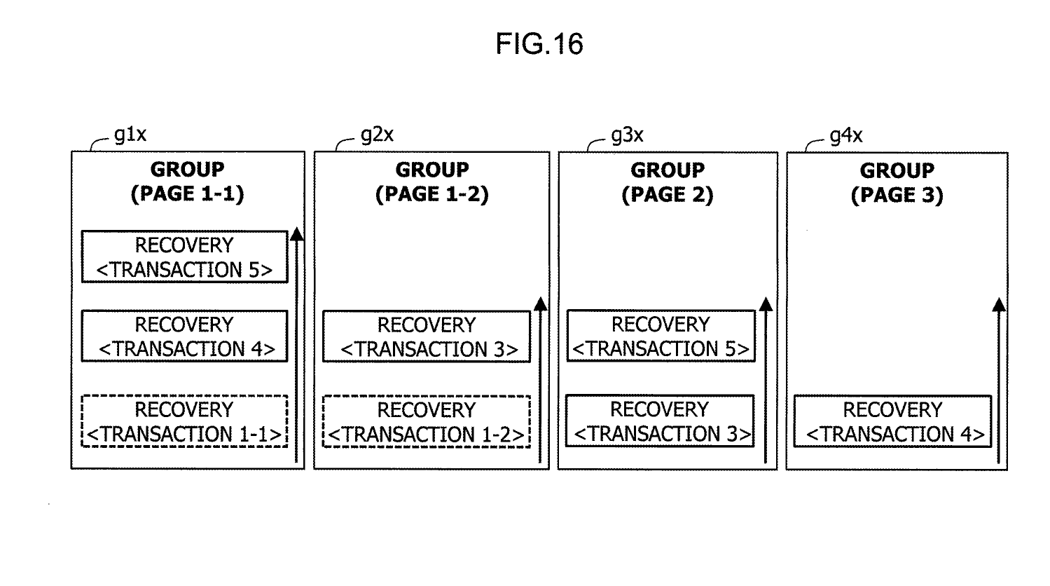

FIG. 16 is a diagram indicating an example of the group which is classified based on quantity of record for the reconstruction. According to the example of FIG. 15, there is much quantity of record of group g1. In addition, in example of FIG. 15, 16, the unit of the area indicates, for example, page “1-1”, “1-2”. And the reconstruction processing of update of page “1-1” “1-2” is feasible in parallel.

Therefore, the recovery module 123 classifies the execution histories belonging to group g1 (FIG. 15) in two group g1x, g2x as indicated in FIG. 16. Thereby, because quantity of the reconstruction processing that each group g1x-g4x performs is smoothed, it is possible to equalize time to spend by the reconstruction processing between groups.

### Flow of the Reconstruction Processing

FIG. 17 is a diagram of flow chart explaining a processing flow of recovery module 123 of DB control program 120 depicted in FIG. 8. The recovery module 123 of DB control program 120 carries out the reconstruction processing depicted in FIG. 17 in response to the reconstruction demand of the database.

S21: The recovery module 123 reads the archive backup log (FIG. 14) ALx depending on a reconstruction demand.

S22: The recovery module 123 judges whether compression is designated in the reconstruction demand. For example, the compression is designated when character string “-COMP” is appointed for a command. When the compression is not designated (No of S22), the recovery module 123 finishes reconstruction processing.

S23: On the other hand, when the compression is designated (YES of

S22), the recovery module 123 judges whether all the execution histories of archive backup log ALx is read.

S24: When there is the execution history which was not read (No of S23), the recovery module 123 judges quantity of target record to update based on an execution history. The recovery module 123 judges a group to request for reconstruction processing based on quantity of target record to update.

S25: The recovery module 123 judges whether or not requests the reconstruction processing based on the execution history to the existing group carrying out for the reconstruction processing.

S26: When requesting to the existing group (Yes of S25), the recovery module 123 requests the existing thread which performs the restoring processing of the group carrying out for the reconstruction processing based on the execution history which is read.

S27: When requesting to the new group (No of S25), the recovery module 123 generates a thread which performs the restoring processing for new group. And the recovery module 123 requests a thread which is formed newly for the reconstruction processing based on the execution history which is read.

In this way, the recovery module 123 does not judge whether the execution history which is read is an execution history of the operation which finished normally. Therefore, it is possible that the recovery module 123 performs reconstruction processing fast. In addition, it is possible that the recovery module 123 effectively classifies execution histories in the group based on page information and quantity of record which are added at a time of backup. Thereby, it is possible that the recovery module 123 carries out reconstruction processing fast and effectively.

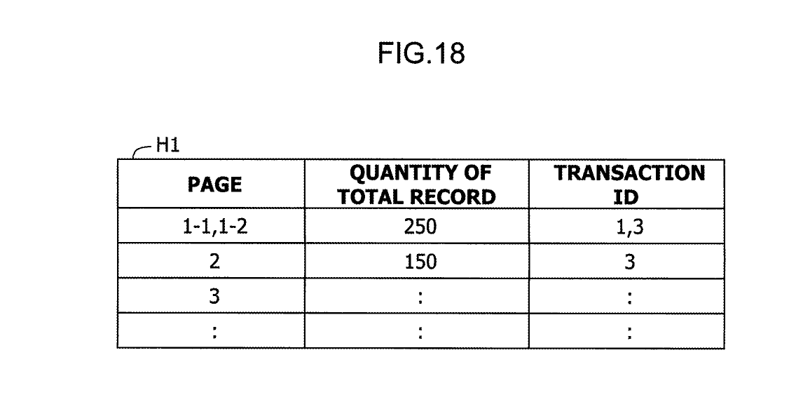

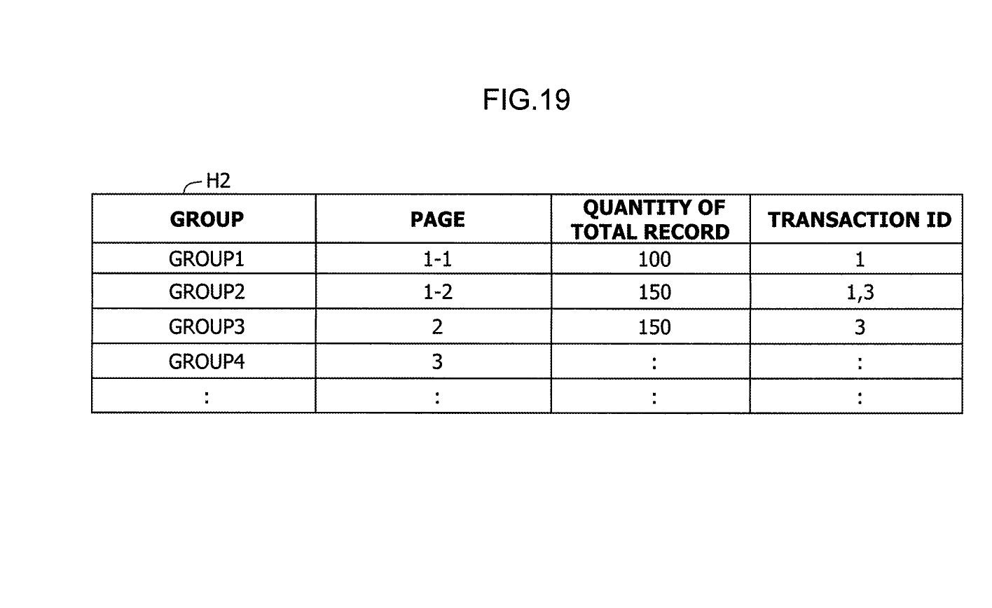

Then, according to FIG. 18 and FIG. 19, processing of process S24 in flow chart of FIG. 17 will be explained.

### Example

FIG. 18 is a diagram explaining the gross weight of the record for the update of each page. Table H1 in FIG. 18 is based on information of archive backup log ALx depicted in FIG. 14. The table H1 has information (page) of the page for the update, the gross weight (quantity of total record) of the record for the update, and the transaction ID that an execution history belongs to. In addition, the table H1 exemplifies the information about the transactions 1, 3, but information about other transaction 4 and 5 are same as that.

The recovery module 123 judges a group to request for reconstruction processing based on quantity of record for the update of each execution history according to the process S24. For example, the case processing reconstruction of transaction 1 and transaction 3 is explained.

According to the table H1, the page “1-1”, “1-2” are update target of the transaction 1, 3 and the quantity of total record for the update is “250” records. In addition, page “2-1” is targeted for update of transaction 3, and the quantity of total record for the update is “150” records. In this way, the quantity of total record for the update of page “1-1” “1-2” is more than the quantity of total record for the update of page “2-1”. Therefore, the recovery module 123 judges to request to the different group for reconstruction processing of update for page “1-1” and page “1-2”.

FIG. 19 is a diagram explaining the group classification of the execution history based on the quantity of record. Table H2 depicted in FIG. 19 has a group, page information, quantity of total record, information of the transaction ID.

According to the table H2, the reconstruction processing of update for page “1-1”, “1-2” is divided by the plural groups (group one or two). The recovery module 123 generates a thread every group (group 1-4) and requests a formed thread for the reconstruction based on the execution history classified in each group.

In this way, the recovery module 123 classifies execution histories in the group so that quantity of total record between groups is smoothed. Thereby, it is possible that the recovery module 123 smooths the processing time needed for the reconstruction processing of each group and shortens the processing time needed for reconstruction processing of database 105.

In addition, the example of FIG. 18 and FIG. 19 exemplifies a case that each group performs the restoring processing of the update of the same page (area). However, the reconstruction processing of the update of the different page may be performed more. For example, the group 1 may perform reconstruction processing of update of page 4 more.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer readable storage medium storing therein a control program that causes a computer to execute a process, the process comprising:
selecting an operation execution log of an operation which is finished normally among a plurality of operation execution logs stored in a first storage in response to an operation which is executed for a second storage; and
storing the operation execution log which is selected in a third storage for backup.

2. The storage medium according to claim 1, wherein the operation comprises an operation for database stored in the second storage,
and wherein the operation finished normally comprises an operation reflected to the database.

3. The storage medium according to claim 2, wherein the operation reflected to the database comprises an operation of series of operation group for the database and an operation that a committing command which establishes update of the operation group is carried out.

4. The storage medium according to claim 3, wherein the operation reflected to the database comprises an operation that processing finished normalcy among a plurality of operations included in the operation group that the committing command was executed.

5. The storage medium according to claim 1, wherein the process further comprises restoring the second storage based on the operation execution log stored in the third storage.

6. The storage medium according to claim 5, wherein the restoring comprises:
classifying the operation execution log stored in the third storage in a plurality of groups that a storage area is not repeated; and
restoring based on the operation execution log of the plurality of groups in parallel.

7. The storage medium according to claim 6, wherein the restoring further comprises classifying the operation execution log stored in the third storage in a plurality of groups according to a quantity of data which is target for the restoring.

8. A control method, the method comprising:
selecting, by a processor, an operation execution log of an operation which is finished normally among a plurality of operation execution logs stored in a first storage in response to an operation which is executed for a second storage; and
storing the operation execution log which is selected in a third storage for backup.

9. The control method according to claim 8, wherein the operation comprises an operation for database stored in the second storage,
and wherein the operation finished normally comprises an operation reflected to the database.

10. The control method according to claim 9, wherein the operation reflected to the database comprises an operation of series of operation group for the database and an operation that a committing command which establishes update of the operation group is carried out.

11. The control method according to claim 10, wherein the operation reflected to the database comprises an operation that processing finished normalcy among a plurality of operations included in the operation group that the committing command was executed.

12. The control method according to claim 8, wherein the method further comprises restoring the second storage based on the operation execution log stored in the third storage.

13. The control method according to claim 12, wherein the restoring comprises:
classifying the operation execution log stored in the third storage in a plurality of groups that a storage area is not repeated; and
restoring based on the operation execution log of the plurality of groups in parallel.

14. An information processing device comprising:
a first storage which stores a plurality of operation execution logs for an operation which is executed for a second storage; and
a processor which executes a process including:
selecting an operation execution log of an operation which is finished normally among the plurality of operation execution logs stored in the first storage; and
storing the operation execution log which is selected in a third storage for backup.

15. The information processing device according to claim 14, wherein the operation comprises an operation for database stored in the second storage,
and wherein the operation finished normally comprises an operation reflected to the database.

16. The information processing device according to claim 15, wherein the operation reflected to the database comprises an operation of series of operation group for the database and an operation that a committing command which establishes update of the operation group is carried out.

17. The information processing device according to claim 16, wherein the operation reflected to the database comprises an operation that processing finished normalcy among a plurality of operations included in the operation group that the committing command was executed.

18. The information processing device according to claim 14, wherein the processor restores the second storage based on the operation execution log stored in the third storage.

19. The information processing device according to claim 18, wherein the processor classifies the operation execution log stored in the third storage in a plurality of groups that a storage area is not repeated, and restores based on the operation execution log of the plurality of groups in parallel.
